(19) United States
(12) Patent Application Publication
(10) Pub. No.: US 2005/0058372 A1
(43) Pub. Date: Mar. 17, 2005

(54) Method for the operation of a laser scanning microscope

(76) Inventors: Ralf Engelmann, Jena (DE); Joerg Engel, Weida (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/888,123

(22) Filed: Jul. 9, 2004

(30) Foreign Application Priority Data
Jul. 11, 2003 (DE) 103 32 060.1

(51) Int. Cl. G06K 7/00; H01S 3/10

(52) U.S. Cl. 382/312; 372/9

(57) ABSTRACT

A method for the operation of a laser scanning microscope and for the detection of a specimen, wherein at least two detected images or image areas are compared to one another and temporal and/or spatial changes in the color and/or intensity lead to the formation of control signals for the illumination and/or detection and/or scanner control and/or other adjustable microscope components, and a laser scanning microscope with detection structure for detecting spatial and/or temporal changes in a specimen and/or in a specimen area and a control element for controlling the illumination and/or detection and/or scanner control and/or other optical and/or electronic microscope components depending on the detected change.

### CROSS-REFERENCE TO RELATED APPLICATION

This application claims priority of German Application No. 103 32 060.1, filed Jul. 11, 2003, the complete disclosure of which is hereby incorporated by reference.

### BACKGROUND OF THE INVENTION

a) Field of the Invention

The invention is directed to a fast change in scanning, particularly of living specimens, by a laser scanning microscope taking place in quasi-real time. The most important advantageously cooperating system components are shown in FIG. 1.

b) Description of the Related Art

Reference is had to DE 19702753 A1, by way of example, for a description of the optical components of a laser scanning microscope.

A laser scanning microscope with fast switching of different wavelengths and/or intensities for different areas of the specimen is described in DE 19829981.

### BRIEF DESCRIPTION OF THE DRAWING

FIG. 1 shows different optical and electronic components K1 and K2 by way of example.

### DESCRIPTION OF THE PREFERRED EMBODIMENTS

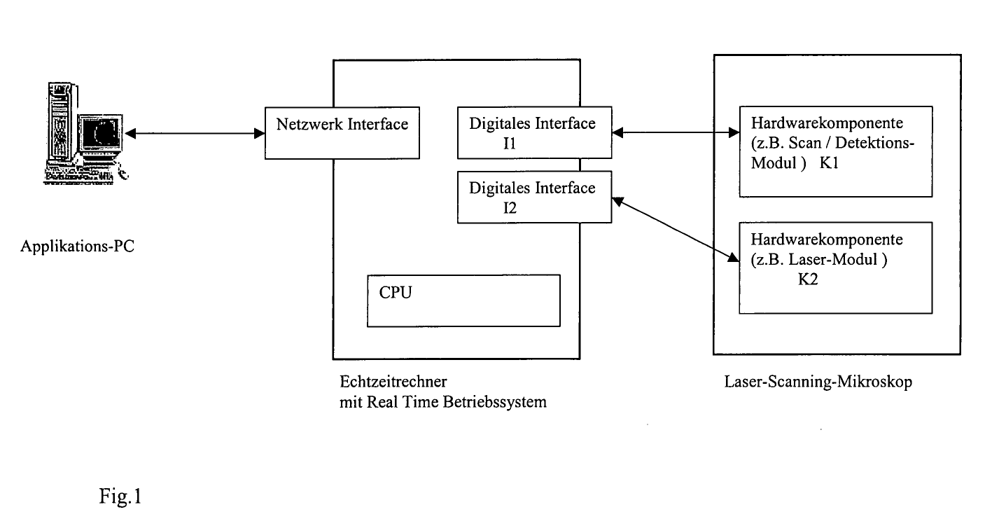

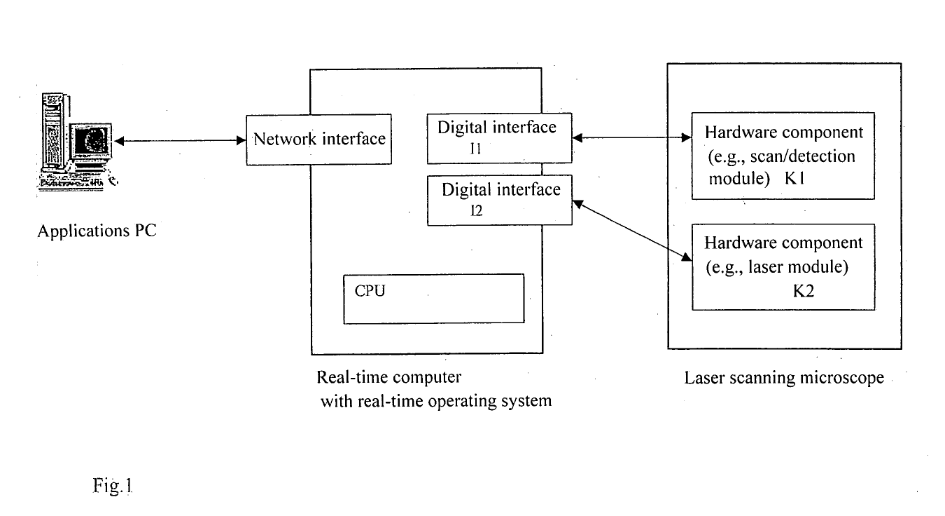

Referring to FIG. 1, K1 can be, for example, the detection module or the scanner control; K2 can be the illumination module with at least one illumination laser and an AOTF for fast wavelength-dependent switching or changing of the intensity of the illumination light.

The following terms are used within the following general meanings:
Specimen: specimen as total unit
Specimen area: portions of the specimen that can be acquired, e.g., in an image
Image: imaging of the specimen in part or in its entirety
Image area: partial area of a larger image
Object: delimited structure within an image area, e.g., a biological cell to be analyzed
ROI: user-defined region of interest, see also “image area”
Scan field: technically defined image area; the area surrounding the scan field that is not imaged is not scanned either passively or actively
Scan line: linear line of any length; the scan field is formed by an orthogonally staggered succession of lines.

Components K1, K2 in the drawing and other components that are not shown are connected by digital interfaces I1, I2 to a computer R which advantageously contains a CPU processor.

Computer R is connected to a user PC containing a display and input devices for the user of the laser scanning microscope.

According to the invention, the scanning system reacts to events taking place on or in the specimen. For this purpose, successively recorded images or image areas are compared to one another and spectral changes or changes in intensity are detected and are used for controlling the device parameters. This can take place in a case in which the scanning speed is increased so that the detection of rapidly occurring events can be improved and made more accurate. The resolution can be reduced for this purpose.

In another case, a change in brightness in the specimen, for example, fading or bleaching of the specimen by the laser irradiation can be reacted to by an increase in the sensitivity.

In another case, periodically occurring processes can be detected and the image recording can be synchronized in time therewith. These processes can take place in the image or also externally (e.g., pulse beat, etc.).

In another case, uniform movements of the specimen, for example, of a cell in a liquid, can be detected and the entire image recording area in the specimen can be tracked.

The image recording area can also be adapted to a determined shape of the specimen and can be changed by changing the specimen shape (ROI, region of interest). The scanning is advantageously carried out by controlling the scanner only within the ROI.

A change such as a bright pulse or a light flash announcing the start of a reaction in the specimen can serve as a starting signal for triggering a recording or series of recordings with predefined recording conditions and scanning parameters.

A change in a specimen area can lead to switching between a large survey image with possibly low resolution to a smaller image section with higher resolution which detects only the active specimen area.

The speed of a process taking place in the specimen can be used to adapt the scanning speed so that rapidly occurring events can be detected with sufficient time resolution. The spatial resolution can possibly be reduced in a corresponding manner. During the acquisition of image data, the dynamic characteristics of the specimen are reacted to in a suitable manner by the real-time system.

The generated image data are analyzed in order to obtain control signals therefrom for the image data recording. These control signals can also be obtained by combining with external signals (triggers, digitized parameters).

The influence extends to at least the following parameters:
size, position, rotation, zoom of the scanning area
speed of data acquisition
scanning mode (spot, line, frame, stack)
quantity of scanned images
time between two data recordings
type of data filtering
intensity of illumination
amplification of the detected signal

The technological prerequisite for all of these reactions is a system such as that described with reference to the illustration, which comprises suitable software components and hardware components in order to calculate the required signals for altered control of the scanners already while the scanning process is running, e.g., in case of a scan field composed of lines: The calculation of the signals for controlling the scanners is not carried out in advance for the entire scanning job, but in small units (scan lines). During the measurement, a new scan line is calculated from the current state of the scanners (position, speed, acceleration) and the desired movement of the scanners. In this way, new requirements can be reacted to flexibly and rapidly during the measurement.

Possible Aspects with Regard to Application:

Object tracking with scanners: The object of interest is defined in an image. When the position of this object changes over a longer period of time during the acquisition of image data, the position is regulated depending on the image data acquisition. This can be carried out in all three spatial coordinates.

Readjustment of the intensity of the scanned signal: The goal is to maintain constant the intensity of the detected signal during image data acquisition over a longer period of time in an area defined beforehand. When the intensity changes (e.g., due to the bleaching of the dye), this is reacted to in a suitable manner.

Readjustment of the illumination intensity

Increase in the PMT voltage or amplification

Reduction in the speed of data acquisition

The reference for the intensity of the detected signal can be measured at a point on the specimen other than in the region of the actual measurement in order to prevent bleaching of the structures of interest in the specimen.

Triggering of image acquisition by image information: The image data are constantly detected in a defined area and the image information is analyzed. When a parameter that has been fixed beforehand is altered (e.g., the mean grayscale value), image data acquisition of the entire specimen is initiated.

Autofocus with scanners: A reference position is defined on the specimen and is used for determining or readjusting the focus position. The reference position can lie outside of the scanning area in order to prevent bleaching of the areas of interest in the specimen during readjustment of the focus position. A relative deviation in x-direction from a measurable reference in the z-plane (e.g., cover slip reflection) is used for readjustment of the focus position.

1. An advantageous application of the invention is the reaction to directed positional changes in living specimens. For this purpose, either a scanning region is tracked or a zoom or region of interest (ROI) is activated.

Fenili and De Boni, Brain Res Protoc 11/2003, pages 101-110, describe the microscopic imaging of living cell formations in a culture, wherein an individual cell must also be displayed permanently with high resolution during changes in position.

Trachtenberg, et al., Nature 420/2002, pages 751-752, describe the repeated imaging of brain structures in long-term experiments over weeks with laser scanning microscopy, wherein changes in position of the specimen must be compensated in order to retain the imaged structure and to find it again.

Zimmer et al., IEEE Trans Med. Imaging 10/2002, pages 1212-1221, describe the automatic detection and tracking of migrating living cells in a culture by post-processing of time-series recordings. A direct implementation of such corrections during image recording would be advantageous.

2. Another advantageous application is the synchronization with regular positional deviations or dynamic processes of interest in living specimens. For this purpose, for example, the image capture is synchronized with the pulse beat of a living animal in order to improve image quality.

Chen et al., Learn. Mem. 7/2000, pages 433-441, describe the imaging of brain structures in long-term experiments over hours or days with laser scanning microscopy, wherein regular movements of the specimen must be compensated by pulse or respiration in order to retain the imaged structure.

3. Another advantageous application is the reaction to dynamic changes in living specimens, e.g., the increase in Ca2+ concentrations in long-term imaging. For this purpose, the scanning speed is adapted to the specimen as a function of the fluorescence dynamics over time.

Woo, et al., J. Physiol. 543/2002, pages 439-453, describe the display of fast Ca2+ processes in rat cells with fast confocal microscopy. For this purpose, very large data sets are generated because of the speed. A control of the speed of the data recording with the dynamics of the processes in the specimen would allow economical data management in long-term experiments.

Zimmer et al., IEEE Trans Med. Imaging 10/2002, pages 1212-1221, describe the analysis of migrating living cells in a culture by time-series recordings. It would be advantageous to adapt the recording rate corresponding to the movement of the cells during the image recording.

4. Another advantageous application of a real-time-controlled scanner is the reaction to creeping changes in image quality, e.g., bleaching out of dye, fluctuations in laser output, changes in pH, or the like. For this purpose, the detection sensitivity is adapted as a function of the global brightness distribution or a reference point outside the specimen.

Chen et al., Learn. Mem. 7/2000, pages 433-441, describe the imaging of brain structures in long-term experiments over hours or days with laser scanning microscopy, wherein changes in the light efficiency through bleaching of the dyes or cloudiness caused by the milieu must be compensated in order to minimize artifacts.

Fenili and De Boni, Brain Res Protoc 11/2003, pages 101-110, describe the microscopic imaging of living cell formations in a culture, wherein an individual cell must be displayed with high resolution during a development process. It would be advantageous to adapt the sensitivity relative to external influences such as fluctuations in laser output.

While the foregoing description and drawings represent the present invention, it will be obvious to those skilled in the art that various changes may be made therein without departing from the true spirit and scope of the present invention.

1-17 (cancelled).

18. A method for the operation of a laser scanning microscope comprising the steps of:
comparing at least two detected images or image areas to one another; and determining temporal and/or spatial changes in color and/or intensity which lead to the formation of control signals for the illumination and/or detection and/or scanner control and/or other adjustable microscope components.

19. A method for the detection of a specimen with a laser scanning microscope comprising the steps of:
comparing at least two recorded images or image areas to one another; and
carrying out a change in the control of the illumination and/or detection and/or scanner control and/or other adjustable microscope components when a change in wavelength and/or intensity occurs at least in a specimen area.

20. A laser scanning microscope comprising:
detection means for detecting spatial and/or temporal changes in a specimen and/or in a specimen area; and
control means for controlling the illumination and/or detection and/or scanner control and/or other optical and/or electronic microscope components depending on the detected change.

21. An arrangement according to claim 20, wherein input means and display means for the user are connected to a processor via interfaces and this processor is connected via interfaces at least to microscope components for illumination and/or detection and/or scanner control.

22. A method for the operation of a laser scanning microscope according to claim 20, wherein a change in brightness on the specimen triggers a control signal for changing the image recording conditions.

23. A method for the operation of a laser scanning microscope according to claim 20, wherein processes occurring periodically on or in the specimen trigger at least one control signal for a synchronized image recording.

24. A method for the operation of a laser scanning microscope according to claim 20, wherein during a movement of the specimen or of specimen areas the scanned field of the movement is tracked.

25. A method for the operation of a laser scanning microscope according to claim 20, wherein a reaction to or in the specimen triggers a control signal for the start of image recording or a series of image recordings.

26. A method for the operation of a laser scanning microscope according to claim 20, wherein a change in a specimen area triggers a control signal for the change in size of the scanned region.

27. A method for the operation of a laser scanning microscope according to claim 20, wherein the speed of a change on or in the specimen forms a control signal for the change in scanning speed.

28. A method according to claim 20 for detecting at least one moving cell in a cell culture.

29. A method according to claim 18 for detecting brain structures in long-term examinations.

30. A method according to claim 18 for detecting pulse beat.

31. A method according to claim 18 for detecting respiration.

32. A method according to claim 18 for detecting temporal changes in living specimens, for example, the change in the Ca2+ concentration.

33. A method according to claim 18 for adapting to the bleaching of dyes in the specimen.

34. A method according to claim 18 for adapting to cloudiness in the specimen.
